(19) United States
(12) Patent Application Publication
(10) Pub. No.: US 2004/0068078 A1
(43) Pub. Date: Apr. 8, 2004

(54) In situ polymerizing medical compositions

(76) Inventor: Michael T. Milbocker, Holliston, MA (US)

Correspondence Address: MICHAEL MILBUCKER, P O BOX 524, MENDON, MA, 01756-0524, US

(21) Appl. No.: 10/651,797

(22) Filed: Aug. 30, 2003

Related U.S. Application Data
(63) Continuation-in-part of application No. 10/020,331, filed on Dec. 12, 2001.
(60) Provisional application No. 60/407,613, filed on Sep. 3, 2002.

(51) Int. Cl. C08G 18/08; C08G 18/16; C08G 18/10

(52) U.S. Cl. 528/48; 528/59

(57) ABSTRACT

Isocyanate-capped biocompatible and optionally biodegradable polymers provide a liquid polymer composition, which can be implanted into a living mammal and which forms an adhesive, a coating, or a solid implant by in situ polymerization and crosslinking upon contact with body fluid or tissue. Formation of the polymerized material typically also involves crosslinking with surrounding tissue and formation of a tissue bond. Methods of using the novel liquid polymers of the invention in mammals are disclosed for providing wound sealing and bonding, formation of a protective barrier to prevent post-surgical adhesions, formation of tissue implants, and release of biologically active agents.

### CROSS REFERENCE TO RELATED APPLICATION

This application claims the benefit of the priority of U.S. 60/407,613, filed Sep. 3, 2002, and is a continuation-in-part of U.S. 10/020,331, filed Dec. 12, 2001.

### FIELD OF THE INVENTION

This invention relates to a class of medical liquids comprising biocompatible and optionally biodegradable polymers capped with isocyanate groups, which polymerizes inside the body to yield a solid or gel that capable of adhering, coating or sealing tissues, or providing an implant.

### BACKGROUND OF THE INVENTION

Some medical materials, such as certain types of sutures, are designed to disappear from the site of implantation over time. These materials either chemically degrade or change phase by dissolution. In this application a material is biodegradable if the chemical composition of the implanted device changes in such a way that the volume and functionality of the material decreases with time. Usually the chemical change consists of a breaking of chemical bonds leading to simpler or lower molecular weight structures, which are typically metabolized or excreted.

In this application a material is absorbable if the structural composition of the implant changes in such a way that the volume and functionality of the material decreases with time. For example, a medical material may dissolve, changing from a solid to a liquid with or without elimination by the body. Or, the material may crumble or fracture, rendering an implant or coating non-rigid or non-occlusive. The materials of this application form solids in situ that are in some instances biodegradable and in other instances absorbable, or both.

The materials of the invention react with each other and with tissue via isocyanate groups. A variety of medical materials are known, including materials that polymerize via reactions of isocyanate groups. The following is a summary of certain references describing implants and materials therefore, noting distinctions with respect to the present invention.

U.S. Pat. No. 4,838,267 (Jamiolkowski et al) describes methods of making block copolymers of biodegradable materials such as glycolide and p-dioxanone. Although those materials are contained in particular embodiments of the present invention, '267 does not describe end capping those copolymers with isocyanate, or grafting on chains of alkylene oxide which are themselves end capped with isocyanate. Further, it does not describe using such compounds in a state that is capable of self-polymerizing in the body.

U.S. Pat. No. 5,578,662 (Bennett et al) describes a bioabsorbable polymer with star-like branching that can be endcapped with isocyanate. However, the claims are specific to endcapping with lysine isocyanate. Lysine isocyanate capping will not produce a prepolymer composition which will chain extend or crosslink, and hence form a solid in living tissue. Furthermore, the method of preparing the compositions requires the use of metal catalysts and solvents, which makes these compositions less biocompatible than those of the present invention. These catalysts and solvents cannot be entirely eliminated from the compositions of '662, but are not required in the synthesis of polymer liquids of the present invention.

U.S. Pat. No. 5,847,046 (Jiang et al) describes a surgical bonding material that polymerizes to form an absorbable implant when a continuous part is mixed with a discontinuous part. Apart from distinctions of chemistry, the composition is fundamentally different from the present invention in that the discontinuous part cannot exist in the continuous part without the initiation of a polymerization cascade. In addition, the polymerization occurs primarily between discontinuous and continuous parts of the invention described in '046, and not between the invention and body fluids and tissue. Thus, the bond to tissue is purely mechanical and not chemical. The present invention is typically chemically bonded to tissue.

U.S. Pat. No. 4,806,614, (Matsuda et al) describes the use of isocyanate-terminated polymers as tissue adhesives. However, Matsuda's adhesive preparations do not contain low molecular weight reactive materials, and are believed to therefore be less effective in bonding to tissue.

US 2003/0032734 (Roby) describes two-part isocyanate based tissue adhesives and mentions one-part compositions. The one part compositions appear to consist of two or three polyalkylene oxie chains stemming from a single carbon, and having degradable groups only at the tips of the PAOs, just before the isocyanate groups. This structure differs from that described herein.

U.S. Pat. No. 6,566,406 (Pathak et al) prepare a crosslinked gel by mixing a succimidate-tipped polymer with a nucleophile-tipped polymer (e.g., an amine) just before application to tissue.

### SUMMARY OF THE INVENTION

In accordance with the present invention, liquid compositions capable of bonding to tissue while forming a coating or solid inside or upon living mammalian tissue described. The liquid compositions are obtained by capping polymeric polyols with a polyisocyanate. The polymeric polyols are optionally biodegradable or absorbable, and may have a controlled degree of swelling. The in situ formed solid, coating or hydrogel, depending on the amount of polyol and on its chemical composition, may exhibit a wide range of moduli, tear strengths, and rates of dispersion.

In one aspect, the invention comprises a liquid composition for treatment of a medical condition in an animal, where the composition comprises self-crosslinkable polymers. The polymers comprise backbone polymers having an average of more than two reactive groups selected from isocyanates and isothiocyanates, so that the composition is capable of polymerizing in the body of a mammal to form a solid bonded to tissue, by reaction with water absorbed from the tissue of the animal. The composition contains a significant amount of low molecular weight polyisocyanates not bound to a polymer.

In addition, the composition is essentially free of any catalyst, and typically is essentially free of any solvent. The composition is liquid under the conditions of use. For example, the composition has a melting point at a temperature of about 45 degrees C. or lower, preferably 25 deg. C or lower. (For compositions which melt as the temperature decreases, melting at or above about 45 deg. C is preferred.)

In the composition, at least some of the backbone polymers in the composition may be rendered biodegradable by the inclusion of monomers or links that will spontaneously hydrolyze in the body, thereby altering the mechanical properties of a polymerized material formed from the polymer. A preferred backbone polymer of the composition is one in which the backbone polymer comprises alkylene oxide monomers; preferable, the backbone is predominantly a polyalkyleneoxide. The polymer preferably has a number-average molecular weight of less than about 20,000 Daltons, and more preferably has a molecular weight of 10,000 or below, to minimize viscosity.

The composition further comprises a low molecular weight polyisocyanate or polyisothiocyanate, with the preferred number-average molecular weight of the LMW-PIC being less than about 1000 Daltons, and wherein the isocyanate and isothiocyanate groups in the low molecular weight material are less than about 30% of the number of isocyanate and isothiocyanate groups bound to the backbone polymer. Expressed in another way, the isocyanate and isothiocyanate groups in the low molecular weight material are preferably present at a concentration of less than about 100 mEq per mole.

The composition may further comprise a particulate material suspended in the composition, or further may comprise a polymeric material not reactive with the polymer or the low molecular weight isocyanate or isothiocyanate, the non-reactive material being dissolved or suspended in the composition. When properly prepared and stored, the composition is stable for at least 1 year when stored at room temperature in the absence of water vapor.

The composition may further comprises a therapeutic agent. It may be used for the medical treatment of an animal, for any condition for which it is useful and in particular for one or more of the closure of wounds, the repair of a hernia or tissue defect, the prevention of tissue adhesions or re-adhesions, the implantation of a deposit in tissue, the treatment of joints and spinal discs, the anastomosis of body structures, the sealing of lungs, the creation of emboli, and the delivery of therapeutic agents. Likewise, the composition may be used for the preparation of a medication for the treatment of an animal, for any condition including those just mentioned.

### DETAILED DESCRIPTION OF THE INVENTION

The invention comprises a liquid preparation for use in medicine, and its uses therein. The liquid preparation contains a reactive polymer, which comprises a “base polymer” or “backbone polymer”, reactive groups on the backbone polymer, and a slight excess of “free” (low molecular weight) polyreactive molecules. The liquid composition is prepared by a method requiring no catalysts and essentially no solvent. The reactive liquid polymer is self-curing when applied to tissue, by absorption of water and other reactive molecules from the tissue. The cured polymer is used to seal tissue to tissue, or to devices; to apply a protective coating to tissue; to form an implant within or upon tissue; to deliver drugs. The cured polymer is optionally provided with biodegradable groups, and has a controllable degree of swelling in bodily fluids.

Backbone Polymers

The backbone polymer will comprise a polymeric segment, of molecular weight about 500 D or more, preferably about 1000 to about 10,000 D, optionally up to about 15 kD or 20 kD. The backbone polymer will contain groups that can be easily derivatized (“capped”) to form the final reactive group. Such groups are preferably alcohols or amines, or optionally sulfydryls or phenolic groups. Examples include polymers such as a polymeric polyol, or optionally a polymeric polyamine or polyamine/polyol. The preferred polyols are polyether polyols, such as polyalkylene oxides (PAOs), which may be formed of one or more species of alkylene oxide. The PAO, when comprising more than one species of alkylene oxide, may be a random, block or graft polymer, or a polymer combining these modes, or a mixture of PAO polymers with different properties. Preferred alkylene oxides are ethylene oxide and propylene oxide. Other oxiranes may also be used, including butylene oxide. PAOs are typically made by polymerization onto a starter molecule, such as a low molecular weight alcohol or amine, preferably a polyol. Starting molecules with two, three, four or more derivatizable alcohols or other derivatizable groups are preferred. The multi-armed PAOs obtained from such starters will typically have one arm for each group on the starter. PAOs with two, three or four terminal groups are preferred. Mixtures of PAOs or other backbone polymers, having variable numbers of arms and/or variation in other properties, are contemplated in the invention.

Common polyols useful as starters in the present invention are aliphatic or substituted aliphatic molecules containing a minimum of 2 hydroxyl or other groups per molecule. Since a liquid end product is desired, the starters are preferably of low molecular weight containing less than 8 hydroxyl or other groups. Suitable alcohols include, for illustration and without limitation, adonitol, arabitol, butanediol, 1,2,3-butanetriol, dipentaerythritol, dulcitol, erythritol, ethylene glycol, propylene glycol, diethylene glycol, glycerol, hexanediol, iditol, mannitol, pentaerythritol, sorbitol, sucrose, triethanolamine, trimethylolethane, trimethylolpropane. Small molecules of similar structures containing amines, sulfhydryls and phenols, or other groups readily reactive with isocyanates, are also useable.

The PAO, or other backbone polymer, may optionally incorporate non-PAO groups in a random, block or graft manner. In particular, non-PAO groups are optionally used to provide biodegradability and/or absorbability to the final polymer. Groups providing biodegradability are well known. They include hydroxy carboxylic acids, aliphatic carbonates, 1,4-dioxane-2-one (p-dioxanone), and anhydrides. The hydroxy carboxylic acids may be present as the acid or as a lactone or cyclic dimmer, and include, among others, lactide and lactic acid, glycolide and glycolic acid, epsilon-caprolactone, gamma-butyrolactone, and delta-valerolactone. Amino acids, nucleic acids, carbohydrates and oligomers thereof can be used to provide biodegradability, but are less preferred. Methods for making polymers containing these groups are well known, and include, among others reaction of lactone forms directly with hydroxyl groups (or amine groups), condensation reactions such as esterification driven by water removal, and reaction of activated forms, such as acyl halides. The esterification process involves heating the acid under reflux with the polyol until the acid and hydroxyl groups form the desired ester links. The higher molecular weight acids are lower in reactivity and may require a catalyst making them less desirable.

The backbone polymers may also or in addition carry amino groups, which can likewise be functionalized by polyisocyanates. Thus, the diamine derivative of a polyethylene glycol could be used. Low molecular weight segments of amine containing monomers could be used, such as oligolysine, oligoethylene amine, or oligochitosan. Low molecular weight linking agents, as described below, could have hydroxyl functionality, amine functionality, or both. Use of amines will impart charge to the polymerized matrix, because the reaction product of an amine with an isocyanate is generally a secondary or tertiary amine, which may be positively charged in physiological solutions. Likewise, carboxyl, sulfate, and phosphate groups, which are generally not reactive with isocyanates, could introduce negative charge if desired. A consideration in selecting base polymers, particularly other than PAOs or others that react only at the ends, is that the process of adding the reactive groups necessarily requires adding reactive groups to every alcohol, amine, sulfhydryl, phenol, etc. found on the base polymer. This can substantially change the properties, particularly the solubility properties, of the polymer after activation.

Reactive Groups

The base or backbone polymer is then activated by capping with low molecular weight (LMW) reactive groups. In a preferred embodiment, the polymer is capped with one or more LMW polyisocyanates (LMW-PIC), which are small molecules, typically with molecular weight below about 1000 D, more typically below about 500 D, containing two or more reactive isocyanate groups attached to each hydroxyl, amine, etc of the base molecule. After reaction of the LMW-PIC with the backbone, each capable group of the backbone polymer has been reacted with one of the isocyanate groups of the LMW-PIC, leaving one or more reactive isocyanates bonded to the backbone polymer via the PIC. The LMW-PIC are themselves formed by conjugation of their alcohols, amines, etc. with suitable precursors to form the isocyanate groups. Starting molecules may include any of those mentioned above as starting molecules for forming PAOs, and may also include derivatives of aromatic groups, such as toluene, benzene, naphthalene, etc. The preferred LMW-PIC for activating the polymer are di-isocyanates, and in particular toluene diisocyanate (TDI) and isophorone diisocyanate, both commercially available, are preferred. When a diisocyanate is reacted with a capable group on the base polymer, one of the added isocyanates is used to bind the diisocyanate molecule to the polymer, leaving the other isocyanate group bound to the polymer and ready to react. As long as the backbone polymers have on average more than two capable groups (hydroxyl, amine, etc.), the resulting composition will be crosslinkable.

A wide variety of isocyanates are potentially usable in the invention as LMW-PICs. Suitable isocyanates include 9,10-anthracene diisocyanate, 1,4-anthracenediisocyanate, benzidine diisocyanate, 4,4′-biphenylene diisocyanate, 4-bromo-1,3-phenylene diisocyanate, 4-chloro-1,3-phenylene diisocyanate, cumene-2,4-diisocyanate, cyclohexylene-1,2-diisocyanate, cyclohexylene-1,4-diisocyanate, 1,4-cyclohexylene diisocyanate, 1,10-decamethylene diisocyanate, 3,3′dichloro-4,4′biphenylene diisocyanate, 4,4′diisocyanatodibenzyl, 2,4-diisocyanatostilbene, 2,6-diisocyanatobenzfuran, 2,4-dimethyl-1,3-phenylene diisocyanate, 5,6-dimethyl-1,3-phenylene diisocyanate, 4,6-dimethyl-1,3-phenylene diisocyanate, 3,3′-dimethyl-4,4′diisocyanatodiphenylmethane, 2,6-dimethyl-4,4′-diisocyanatodiphenyl, 3,3′-dimethoxy-4,4′-diisocyanatodiphenyl, 2,4-diisocyantodiphenylether, 4,4′-diisocyantodiphenylether, 3,3′-diphenyl-4,4′-biphenylene diisocyanate, 4,4′-diphenylmethane diisocyanate, 4-ethoxy-1,3-phenylene diisocyanate, ethylene diisocyanate, ethylidene diisocyanate, 2,5-fluorenediisocyanate, 1,6-hexamethylene diisocyanate, isophorone diisocyanate, lysine diisocyanate, 4-methoxy-1,3-phenylene diisocyanate, methylene dicyclohexyl diisocyanate, m-phenylene diisocyanate, 1,5-naphthalene diisocyanate, 1,8-naphthalene diisocyanate, polymeric 4,4′-diphenylmethane diisocyanate, p-phenylene diisocyanate, 4,4′,4″-triphenylmethane triisocyanate, propylene-1,2-diisocyanate; p-tetramethyl xylene diisocyanate, 1,4-tetramethylene diisocyanate, toluene diisocyanate, 2,4,6-toluene triisocyanate, trifunctional trimer (isocyanurate) of isophorone diisocyanate, trifunctional biuret of hexamethylene diisocyanate, and trifunctional trimer (isocyanurate) of hexamethylene diisocyanate.

In general, aliphatic isocyanates will have longer cure times than aromatic isocyanates, and selection among the various available materials will be guided in part by the desired curing time in vivo. In addition, commercial availability in grades suitable for medical use will also be considered, as will cost. At present, toluene diisocyanate (TDI) and isophorone diisocyanate (IPDI) preferred. The reactive chemical functionality of the liquids of the invention is preferably isocyanate, but may alternatively or in addition be isothiocyanate, to which all of the above considerations will apply.

Methods of Synthesis

The method will be described in reference to a polymeric polyol, but it should be noted that the description is also applicable to a polymeric polyamine, polysulfhydryl, or polyphenol, or combination of these groups. The term “polymeric polyol” is used herein to also encompasses polymers containing such groups in addition to, or in place of, hydroxyl groups, unless otherwise stated, or unless inherently not possible.

The objective in the synthesis is to take a backbone polymer with two or more hydroxyl groups (a polymeric polyol) (or other derivatizable groups) and convert it into a reactive polymer in which the reactive groups each carry an active isocyanate group. The synthesis is preferably accomplished without addition of solvents, or of catalysts. A preferred method of adding an isocyanate group to every alcohol is to mix an excess of a di-isocyanate with the base polymer. For example, mixing ethylene diisocyanate (an example of a LMW-PIC) with R(OH)N yields R[OC(═O)NHCH₂CH₂N═C═O]ₙ, which is a poly-isocyanate polymer with n pendant isocyanate groups. This is typically accomplished by slow addition of the LMW-PIC to the polymer at elevated temperatures under nitrogen sparging, to improve reaction rate and to remove the water generated by the reaction.

Physical Properties of the Product

The polymerizable materials of the invention are typically liquids at or near body temperature (i.e., below about 45 deg. C), and preferably are liquid at room temperature, ca. 20-25 deg. C, or below. The liquids are optionally carriers of solids. The solids may be biodegradable or absorbable. The liquid polymerizable materials are characterized by polymerizing upon contact with tissue, without requiring addition of other materials, and without requiring pretreatment of the tissue, other than removing any liquid present on the surface(s) to be treated. A related property of the polymerizable materials is that they are stable for at least 1 year when stored at room temperature (ca. 20-25 degrees C.) in the absence of water vapor. This is because the material has been designed so that both the reaction that polymerizes the polymers, and the reactions that optionally allow the polymer to degrade, both require water to proceed.

In contrast to previous formulations, the polymeric polyisocyanates contain a low residual level of low molecular weight (LMW) polyisocyanates (PIC). For example, the final concentration of LMW-PIC isocyanate groups in the formulation, expressed as the equivalent molarity of isocyanate groups attached to LMW compounds, is normally less than about 1 mM (i.e., 1 mEq), more preferably less than about 0.5 mEq and most preferably less than about 0.4 mEq. However, it is preferred that the level of LMW isocyanate groups be finite and detectable, for example greater than about 0.05 mEq, and more preferably greater than about 0.1 mEq. It is believed that having a low but finite level of LMW-PIC molecules tends to promote adherence between the applied polymer formulation and the tissue being treated. However, decreased levels of LMW-PIC may tend to decrease tissue irritation during application and cure of the liquid polymer preparation. It is believed that the range of about 1 mEq to about 0.05 mEq is approximately optimal. In situations requiring tissue adherence in the presence of significant biological fluid, or in adherence to difficult tissues, greater levels of LMW-PIC isocyanate groups may be preferred.

Swellability

The active prepolymers of this invention may form intertwined polymer chains after reaction that may change their intertwined geometry under action by fluids within the body. In particular, one or more components may cause the formed polymeric material, whether as coating, adhesive, or solid, to swell. Swelling may have several consequences, and can be controlled. In one mode, swelling can lead to subsequent break-up (physical disintegration) of an implant or other final form, rendering the entire implant absorbable. Or, one or more of the components may dissolve in the body rendering the remaining components absorbable. Dissolvable materials could be added as solids, or as nonreactive polymers diluting the reactive components.) Or, one or more components may be biodegradable rendering the remaining components absorbable. For example, liquids of the present invention containing a polyethylene/polypropylene random coblock polyol capped with polyisocyanate are capable of forming elastic gels with water content as high as 90%. When these polyethylene/polypropylene polyols are esterified with a carboxylic acid and reacted with a trifunctional molecule such as trimethylolpropane, or alternatively when the trifunctional molecule is esterified and reacted with diols of polyethylene/polypropylene, useful activated polyols are formed. These polyols, when end capped with a polyisocyanate are capable of forming gels or solids in a living organism that decrease in volume and strength over time.

However, the ratio of propylene oxide to ethylene oxide can be varied, and the two monomers can be polymerized into block copolymers, random copolymers, or graft copolymers. These types are commercially available. While the ethylene oxide groups tend to absorb water, and so to swell the crosslinked material formed in the body, the propylene oxide groups are less hydrophilic, and tend to prevent swelling in aqueous fluids. Thus, the degree of swelling of the polymerizedmaterial in water can be controlled by the design of the reactive polymers. Another route of swelling control is by incorporation of non-PAO groups, such as aliphatic or aromatic esters, into the polymer (as, or in addition to, esters used to confer degradability.)

The prepolymer of the present invention is formed by capping the polyols (as backbone polymer) with polyisocyanate, preferably a diisocyanate. However, suitable isocyanates have the form R(NCO)ₓ, where x is 2 to 4 and R is an organic group. Another approach to creating an in situ polymerizing liquid that biodegrades in the body is to graft the polyol onto a biodegradable center. Suitable polymers for inclusion as center molecules are described in U.S. Pat. No. 4,838,267. They include alkylene oxalates, dioxepanone, epsilon-caprolactone, glycolide, glycolic acid, lactide, lactic acid, p-dioxanone, trimethylene carbonate, trimethylene dimethylene carbonate and combinations of these.

The center molecule may be a chain, a branched structure, or a star structure. Suitable star structures are described in U.S. Pat. No. 5,578,662. Isocyanate capped alkylene oxide can be reacted with these molecules to form one or more extended chains. The ends of these chains can therefore participate in crosslinking with other centers or bond to tissue.

Center molecules such as those listed above will form rigid solids upon polymerization. Therefore, it is generally more useful to ensure at least 80% alkylene oxide is in the final polymerized structure. Furthermore, the alkylene oxide should be comprised of at least 70% ethylene oxide.

These criteria ensure that the polymerized product is flexible enough to prevent stress localization and associated tissue bond failure. Furthermore, star molecules in general will not be preferred since they contain numerous branches. More numerous branching of the center molecule is associated with higher liquid viscosity. Furthermore, highly branched prepolymers will form polymerized products more slowly and with higher modulus. For example, U.S. Pat. No. 5,578,662 quotes a cross-linking reaction time of 5 minutes to 72 hours. Both of these characteristics are undesirable when the prepolymer is intended as a surgical adhesive or sealant.

Absorbable Compositions and Particulate Additives

Absorbable prepolymer systems can be composed of discontinuous (solid) and continuous (liquid) parts. The solid part may be absorbable or may not be absorbable. One of the simplest forms of an absorbable implant is one that mechanically breaks into small pieces without appreciable chemical modification. Fracture of an implant can be seeded or propagated by the placement of hard centers in the polymer during formation.

Mixing the liquid polymer of the present invention with calcium triphosphate particles will after exposure to fluids or tissue polymerize into an elastic solid containing an inelastic particulate. Movement of the surrounding tissue will deform the elastic implant. Since the particulate cannot deform, stress will localize around these centers and cracks will begin to propagate from these centers. In this way, the rate of disintegration and size of the disintegrated parts can be controlled by varying the particulate size, the modulus of the formed continuous polymer, and the density distribution of the particulate.

Non-absorbable solid are well known and include, as examples and without limitation, calcium triphosphate, calcium hydroxylapatite, carbon, silicone, Teflon, polyurethane, acrylic and mixture of these. Absorbable solids are well known and include, as examples and without limitation, glycolic acid, glycolide, lactic acid, lactide, dioxanone, epsilon-caprolactone, trimethylene carbonate, hydroxybutyrate, hydroxyvalerate, polyanhydrides, and mixtures of these.

Other absorbable prepolymer liquids can be composed of two continuous mechanically mixed parts. For example, one part may be absorbable and the other not. Consequently, the absorption of one part results in the mechanical disintegration or weakening of the implant. Absorbable components may include liquid forms of cellulose ether, collagen, hyaluronic acid, polyglycolic acid, glycolide and others well known in the art. These systems are not excluded in the present invention, but are also not preferred for the reasons stated above.

Typical Polymer Structures

There are several ways in which the above-recited steps can be used to obtain a liquid reactive polymer system useful in the invention. In a very simple system, a polymeric polyol with a number of end groups on average greater than two is treated with a slight excess of a LMW-PIC, such as toluene diisocyanate. The reaction product is formed under nitrogen with mild heating, preferably by the addition of the LMW-PIC to the polymer. The product is then packaged under nitrogen, typically with no intermediate purification.

A preferred biodegradable polyol composition includes a trifunctional hydroxy acid ester (e.g., several lactide groups successively esterified onto a trifunctional starting material, such as trimethylolpropane, or glycerol). This is then mixed with a linear activated polyoxyethylene glycol system, in which the PEG is first capped with a slight excess of a LMW-PIC, such as toluene diisocyanate. Then the activated polymer is formed by mixing together the activated polyoxyethylene glycol and the lactate-triol. Each lactate triol binds three of the activated PEG molecules, yielding a prepolymer with three active isocyanates at the end of the PEG segments, and with the PEG segments bonded together through degradable lactate groups. In the formed implant, the lactate ester bonds gradually degrade in the presence of water, leaving essentially linear PEG chains that are free to dissolve or degrade. Interestingly, in this system, increasing the percentage of degradable crosslinker increases rigidity, swell and solvation resistance in the formed polymer.

Other polyol systems include hydroxy acid esterified linear polyether and polyester polyols optionally blended with a low molecular weight diol. Similarly, polyester and polyether triols esterified with hydroxy acid are useful. Other polyol systems include the use of triol forming components such as trimethylolpropane to form polyols having three arms of linear polyether chains.

Uses for the Compositions of the Invention

Wound Healing Compositions

The liquids described in this invention can be used to treat wounds. For example their adhesive quality can bring surfaces together and hold them together to promote healing. Also, the material can be coated over a damaged surface to prevent fluid leakage and to promote healing. Also the liquid can be functionalized to promote healing, either by providing a pharmaceutical additive or by adding charge to the polymer. The placement of charge on a polymer in contact with tissue can promote wound healing. These curative charges can be induced on the capped end of the polymer. For example, addition of diethylethanolamine results in formation of positively charged diethylaminoethyl groups on the polymer. Conversely, a negative charge may be induced by reacting the end-capped polymer with carboxymethanol, which forms carboxymethyl groups on the polymer. Alternatively, as described above, charges can be present in the small “starter” molecules onto which the polymers are polymerized.

In application, the tissue or the wound is dried, or at least freed of expressed liquid, and the prepolymer is applied to the site, for example with a syringe. The tissue is held in place while the activated polymer crosslinks to hold the would closed. Alternatively, a fabric can be placed over the polymer on or near the wound, and pressed in place until cure is achieved. Prepolymers for this use are generally preferred to be degradable, but for wounds on the skin or elsewhere where the polymer can safely slough off, a non-degradable formulation may be preferred.

Anti-Adhesion Compositions

Edlich et al in the Journal of Surgical Research, v. 14, n. 4, April 1973, pp 277-284 describes the results of applying a topical solution of 10% ethylene oxide/propylene oxide copolymer to wounds. Reduced inflammatory response at the wound was found for copolymer solutions containing ethylene oxide:propylene oxide in the ratio of 4:1. Inflammation is known to be associated with adhesion formation around surgical sites.

One of the applications of the present invention is surgical repair of tissue. The polymer of the present invention is preferably comprised of an isocyanate-capped and subsequently crosslinked structure of polyethylene oxide-co-polypropylene oxide (PEPO). Under biodegradation or absorption of the in situ formed crosslinked polymer tissue coating, essentially whole chains of PEPO are released into the body. The decomposition of the implant provides for a continuous supply of PEPO, which can serve as an anti-adhesion agent during wound healing. Since polyoxyalkylene block copolymers are absorbed by tissues, the degradation products are eventually excreted in a non-metabolized form.

Further increases in the rate of release of PEPO can be made by adding PEPO directly to the prepolymer of this invention, in a form in which the free ends of the PEPO are blocked, for example by methylation, so that they will not react with isocyanates. The result is a prepolymer which will spatially trap PEPO within a hydrogel, such that the action of water in the body is both to initiate crosslink formation between the isocyanate capped polyols and tissue as well as form a hydrogel with the non-isocyanate-capped PEPO.

The three dimensional structure of the crosslinked implant holds the PEPO hydrogel by hydrogen bonds and similar dynamic restraints. Since these bonds are reversible, thermodynamic considerations will drive the PEPO to slowly elute from the implant. This action will decrease the volume of the implant, without breaking the bonds of the crosslinked structures. Thus, an absorbable implant is formed having potentially both absorption and decomposition pathways to volume loss.

There are three basic approaches to preventing post-surgical adhesions. The first involves the use of a lubricious liquid placed around the surgical site to create a situation termed in the prior art as “hydroflotation”. Hydroflotation prevents tissue surfaces from coming into contact and forming adhesions. The second in involves the placement of a solid layer between tissues surfaces to separate them. The third involves the adherence of a separating layer to tissue to both prevent contact between tissue layers and to seal damaged tissue sites. The release of biologically active fluids from wounded tissue is known to promote adhesion formation.

It should be clear from the above description of the PEPO supplemented prepolymer that all three anti-adhesion mechanisms are uniquely provided in this embodiment of the present invention. Generally, a slowly-biodegradable composition is preferred. Swelling of the applied layer may or may not be preferred, depending on whether swelling could produce obstruction, etc, during the early stages of healing.

Tissue Enhancement

The use of polymers for tissue bulking and similar applications requiring forming a polymer deposit in tissue is described in our patent U.S. Pat. No. 6,296,607, which is hereby incorporated by reference. The polymers of the present invention are suitable for this application. In many cases, non-degradable polymers are preferred, but the degree of swelling may need to be controlled or limited to maximize predictability of result. Tissue enhancement has a wide range of uses. Among the more prominent are alleviation of gastro-esophageal reflux disease (GERD), and alleviation of urinary and fecal incontinence.

Additional Uses

Additional uses for tissue adherent polymeric gels, whether biodegradable or not, include repair of hernias and similar tissue defects (see below), and orthopedic uses, including fixation of the nuclei of spinal discs, replacement of spinal discs, and reinforcement of annuli of disks, as well as uses within joints to protect cartilage, etc. Other uses include anastamosis (vascular, intestinal, urethral, etc.), sealant (e.g., lung), and embolic agent (for aneurysms and the like). The composition may be used, by itself or in conjunction with structural or repair functions, for the formation of a local depot containing one or more therapeutic agents. “Therapeutic agent” is used broadly, and includes drugs, broadly defined, as well as vaccines, anti-allergenic substances, living cells, organelles, viruses and vectors. Therapeutic agents may be encapsulated in protective coatings that will dissolve or become permeable in the body, and may be added at the time of use of the composition.

### EXAMPLES

Example A. Biodegradable In Situ Polymerizing Implant (Lactated Trimethylolpropane) UCON 75-H450, a PEPO polymer from Union Carbide (Danbury, Conn.) having a 25:75 ratio of PO to EO monomers, a molecular weight of about 980 D, and having two hydroxyl ends, was dried by heating at 82° C. for 6 hours at 2 Torr of pure nitrogen flowing at 1 cubic foot per hour. Trimethylolpropane (TMP) was lactated by mixing 269 g of TMP with 1486 g of 85% lactic acid and heating at 2 Torr of pure nitrogen flowing at 1 cubic foot per hour for 2 hours at 110° C. and subsequently for 24 hours at 125° C.

1244 g of dried UCON 75-H-450 was mixed with 133 g of lactated TMP and heated at 82° C. under nitrogen flow of 1 cubic foot per hour for 8 hours. Toluene diisocyanate (TDI) was subsequently added to obtain a theoretical NCO content of approximately 3.0 and heated at 82° C. under nitrogen flow of 1 cubic foot per hour for 24 hours.

Example B. Absorbable Material for In Situ Polymerizing Implant (Pure Polyethylene Glycol) Certain polyols are highly hydrophilic, such a polyethylene glycol (PEG), and will swell and subsequently dissolve in the body. Carbowax 1000, a 1000 MW PEG, was dried according to the procedure of Example A. 1269 g of dried Carbowax 1000 was mixed with 53.9 g of TMP and heated at 82° C. for 8 hours under nitrogen flow of 1 cubic foot per hour. Subsequently, TDI was added to obtain a theoretical NCO content of 2.8 and heated at 82° C. for 24 hours under a nitrogen flow of 1 cubic foot per hour.

Example C. Absorbable Material for In Situ Polymerizing Implant (Reduced Trifunctionality) The polyol of Example B was made less trifunctional by reducing the amount of TMP used. For example, 1902 g of UCON 75-H-1400 was dried and mixed with 34 g TMP and heated under a 2 Torr nitrogen flow of 1 cubic foot per hour for 8 hours at 82° C. After the TMP is consumed, TDI is added in sufficient quantity to obtain a theoretical NCO content of 2.5 and heated at 82° C. under a nitrogen flow of 1 cubic foot per hour for 24 hours.

Example D. Biodegradable Material for In Situ Polymerizing Implant (Lactated Diol) 2450 g of dried UCON 75-H-450 was mixed with 900 g of 85% lactic acid and heated at 85° C. under a nitrogen flow of 1 cubic foot per hour for 8 hours. 1274 g of lactated UCON 75-H-450 was mixed with 24 g of TMP and 490 g of UCON 75-H-450 and dried. After dry, the mixture was reacted for a further 4 hours at 85° C.

Example E. Nonabsorbable Material for Wound Sealing and Hernia Repair 823 g of dried UCON 75-H-450 (MW 980 g; 0.84 mole; 1.68 Eq) was charged to a dry reactor, followed by 278 g (MW 222 g; 1.25 mole; 2.5 Eq) of isophorone diisocyanate (IPDI) (Aldrich Chemicals). The reactor was sealed, and nitrogen flow (ca. 1 cubic foot per 8 hr), stirring, and heating were initiated. The temperature was maintained at 78 deg. C for 120 hrs. Then 22.4 g of trimethylol propane (TMP; MW 134 g; 0.163 mole; 0.5 Eq) was added, and the mixture was maintained under stirring and nitrogen at 78 deg. C for 24 hours. Samples were taken for assay. Total—NCO was assayed by ASTM D2572-97, and found to be about 2.5% (weight NCO/weight polymer). The material was cooled to 50 deg. C and placed in a sealed container. The final product had a molecular weight of about 4500 (number average) and the polymer was about 0.340 mEq/kg. The product also contained about 0.027 mEq/kg of LMW-PIC groups, assumed to be unreacted IPDI.

Example F. Nonabsorbable Material for Wound Sealing and Tissue Augmentation Under the same conditions as Example E, 894 g of dried UCON 75-H-450 plus 205 g of toluene diisocyanate (TDI) were reacted. TDI, MW 174, was the 80:20 isomeric ratio product (of 2,4-TDI to 2,6-TDI) from Aldrich. After 120 hours, 8 g. of TMP was added and heating and stirring under nitrogen was continued. The product was assayed, cooled to ca. 50 deg. C, and bottled.

Example G. Hernia Repair Using Materials of the Invention The material of Example E was used as a glue to adhere repair patches to simulated hernias. Twelve Wilshire pigs were implanted with three types of mesh. The first type was a SurgiPro plug and patch mesh set consisting of a plug formed from mesh to be inserted into the herniation and an overlaying mesh sheet (4×10 cm). The second type was a polypropylene mesh (Surgipro) measuring 10×10 cm. The third type was a polyester mesh measuring 10×10 cm.

The Plug and Patch was implanted by filling a surgically formed abdominal defect with the plug and gluing the patch over the filled defect. A 0.1 cc volume of surgical adhesive was place as a dot midway along each edge of the patch. Four 0.1 cc applications were applied in total per patch. The polypropylene and polyester meshes were implanted similarly, with 20 applications of 0.1 cc of glue uniformly distributed on the perimeter of each mesh.

Controls consisted of side-by-side mesh implantations using suture. Each glue application in the glue fixed meshes was replaced by a suture placement in the control meshes. Two animals received 3 cc of glue by itself, applied in the groin region. All mesh positions were identified by two orthogonally placed sutures 1 cm distant from the mesh. The animals were survived 90 days. At necropsy the mesh were exposed and their dimension, position with respect to the suture marker, and mesh adherence to tissue were measured. Histology was taken of the liver, kidney, and adjacent lymph nodes as well as tissue at the interface of the mesh.

Marked inflammation was identified for polypropylene mesh. Moderate inflammation was identified for polyester mesh. Minimal to no inflammation was found in the region where surgical adhesive was placed alone, without mesh.

TABLE 1
Comparative results of hernia mesh implantation
Patch Migration (in cm, sum of X and Y movement vs. markers)

| Plug and Patch | Glue | 1.5 +/− 1.3 cm |
|---|---|---|
| | Suture | 2.0 +/− 1.2 |
| Polypropylene | Glue | 2.3 +/− 0.8 |
| | Suture | 2.8 +/− 2.8 |
| Polyester | Glue | 2.3 +/− 0.3 |
| | Suture | 2.0 +/− 1.6 |

Pull Force (in Newtons, to obtain release of the patch;
pull is normal to tissue surface)

| | | |
|---|---|---|
| Plug and Patch | Glue | 64 N |
| | Suture | 90 N |
| Polypropylene | Glue | 134 N |
| | Suture | 166 +/− 39 N |
| Polyester | Glue | 144 +/− 40 N |
| | Suture | 195 +/− 35 N |

Shrinkage (apparent shrinkage of patch)

| | | |
|---|---|---|
| Plug and Patch | Glue | 92% +/− 9 |
| | Suture | 88% +/− 13 |
| Polypropylene | Glue | 78% +/− 6 |
| | Suture | 84% +/− 15 |
| Polyester | Glue | 86% +/− 9 |
| | Suture | 92% +/− 7 |

In summary, in this early stage of optimization, the glue preformed comparably to a suture in retaining the patches, and did not show extra inflammation or other deleterious effects.

The above description should not be construed as limiting, but as exemplification of embodiments presented to illustrate the practice of the invention. Those skilled in the art will envision other modifications within the scope and spirit of the claims appended hereto.

What is claimed is:

1. A liquid composition for treatment of a medical condition in an animal, the composition comprising self-crosslinkable polymers, the polymers comprising backbone polymers having an average of more than two reactive groups selected from isocyanates and isothiocyanates, the composition being capable of polymerizing in the body of a mammal to form a solid bonded to tissue by reaction with water absorbed from the tissue of the animal; and wherein the composition contains a significant amount of low molecular weight polyisocyanates not bound to a polymer.

2. The composition of claim 1 wherein the composition is essentially free of any catalyst.

3. The composition of claim 1 wherein the composition is essentially free of any solvent.

4. The composition of claim 1 wherein the composition has a melting point at a temperature of about 45 degrees C. or lower.

5. The composition of claim 1 wherein at least some of the backbone polymers in the composition are rendered biodegradable by the inclusion of monomers or links that will spontaneously hydrolyze in the body, thereby altering the mechanical properties of a polymerized material formed from the polymer.

6. The composition of claim 1 in which the backbone polymer comprises an alkylene oxide monomer.

7. The composition of claim 1 wherein the polymer has a number-average molecular weight of less than about 20,000 Daltons.

8. The composition of claim 1 wherein the composition further comprises a low molecular weight polyisocyanate or polyisothiocyanate, the number-average molecular weight being less than about 1000 Daltons, wherein the isocyanate and isothiocyanate groups in the low molecular weight material are less than about 30% of the number of isocyanate and isothiocyanate groups bound to the polymer.

9. The composition of claim 1 wherein the isocyanate and isothiocyanate groups in the low molecular weight material are at a concentration of less than about 100 mEq per kilogram of composition.

10. The composition of claim 1 wherein the composition further comprises a particulate material suspended in the composition.

11. The composition of claim 1 wherein the composition further comprises a polymeric material not reactive with the polymer or the low molecular weight isocyanate or isothiocyanate, the non-reactive material being dissolved or suspended in the composition.

12. The composition of claim 1 wherein the composition is stable for at least 1 year when stored at room temperature in the absence of water vapor.

13. The composition of claim 1 wherein the composition further comprises a therapeutic agent.

14. The use of the composition of claim 1 for the medical treatment of an animal.

15. The use of claim 14 wherein the treatment is for one or more of the closure of wounds, the repair of a hernia or tissue defect, the prevention of tissue adhesions or re-adhesions, the implantation of a deposit in tissue, the treatment of joints and spinal discs, the anastomosis of body structures, the sealing of lungs, the creation of emboli, and the delivery of therapeutic agents.

16. The use of the composition of claim 1 for the preparation of a medication for the treatment of an animal.

17. The medication of claim 16 wherein the treatment is for one or more of the closure of wounds, the repair of a hernia or tissue defect, the prevention of tissue adhesions or re-adhesions, the implantation of a deposit in tissue, the treatment of joints and spinal discs, the anastomosis of body structures, the sealing of lungs, the creation of emboli, and the delivery of therapeutic agents.
